(19) United States
(12) Patent Application Publication
(10) Pub. No.: US 2004/0119990 A1
(43) Pub. Date: Jun. 24, 2004

(54) Kiosk image processing system

(76) Inventors: Robert W. Miller, Canton, OH (US); Scott J. Waite, Canton, OH (US); Samuel L. Matheny, North Canton, OH (US); Randy W. Breit, Akron, OH (US)

Correspondence Address: BENESCH, FRIEDLANDER, COPLAN & ARONOFF LLP, ATTN: IP DEPARTMENT DOCKET CLERK, 2300 BP TOWER, 200 PUBLIC SQUARE, CLEVELAND, OH, 44114, US

(21) Appl. No.: 10/696,619

(22) Filed: Oct. 29, 2003

Related U.S. Application Data
(60) Provisional application No. 60/423,210, filed on Nov. 1, 2002.

(51) Int. Cl. G06F 15/00

(52) U.S. Cl. 358/1.2; 358/1.15; 358/1.13

(57) ABSTRACT

Systems, methodologies, and other embodiments associated with a kiosk image processing system are described. One exemplary system embodiment comprises an image input device configured to receive a physical image and cause a digital image to be generated from the physical image. An image processing logic can be configured to process the digital image into a selected enlarged size. The example system can also include a large format print mechanism configured to print the digital image into a hardcopy image having the selected enlarged size.

### CROSS-REFERENCE TO RELATED APPLICATIONS

This application claims the benefit of U.S. Provisional Application, titled “Kiosk Image Processing System,” serial number 60/423,210, filed Nov. 1, 2002, which is hereby incorporated by reference in its entirety.

### BACKGROUND

At one time or another, a person has a photograph that they wish to be enlarged such as to a poster size. Typically, the photograph would be taken to a photo lab or photograph processing store where the photograph is dropped off. Hours or even days later, a poster size duplicate is generated. The person would then return to the photo lab and retrieve the poster size duplicate.

### BRIEF DESCRIPTION OF THE DRAWINGS

The accompanying drawings, which are incorporated in and constitute a part of the specification, illustrate various example systems, methods, and so on that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example kiosk image processing system.

FIG. 2 illustrates an example methodology of generating a large format image from a kiosk image processing system.

FIG. 3A illustrates an example system diagram of one embodiment of a kiosk system.

FIG. 3B illustrates another example system diagram of another embodiment of a kiosk system shown in FIG. 3A.

FIG. 4 is another embodiment of a kiosk imaging system with network capabilities.

FIG. 5 is an example methodology of generating a large format image.

FIG. 6 illustrates an example computing environment in which example systems and methods illustrated herein can operate.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks, dynamic memory and the like. Transmission media may include coaxial cables, copper wire, fiber optic cables, and the like. Transmission media can also take the form of electromagnetic radiation, like those generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another component. For example, based on a desired application or needs, logic may include a software controlled microprocessor, discrete logic like an application specific integrated circuit (ASIC), a programmed logic device, a memory device containing instructions, or the like. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communication flow, and/or logical communication flow may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a bus, a logic device, software, or other entity. Logical and/or physical communication channels can be used to create an operable connection.

“Signal”, as used herein, includes but is not limited to one or more electrical or optical signals, analog or digital, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, PerI, SQL, APIs, SDKs, assembly, firmware, microcode, and/or other languages and tools. Software, whether an entire system or a component of a system, may be embodied as an article of manufacture and maintained as part of a computer-readable medium as defined previously. Another form of the software may include signals that transmit program code of the software to a recipient over a network or other communication medium.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

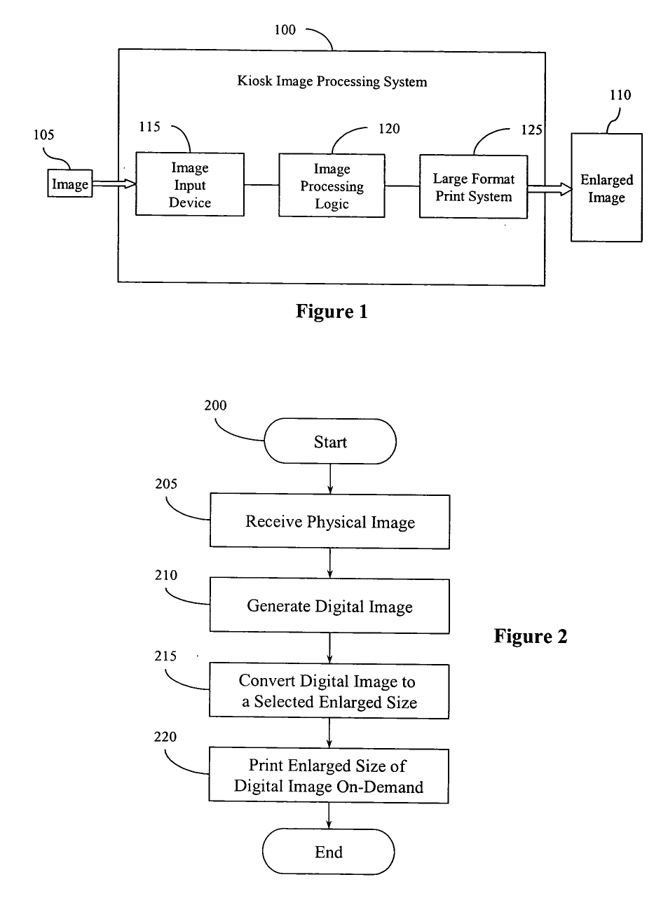

Illustrated in FIG. 1 is one embodiment of a kiosk image processing system 100 configured to generate print images on-demand. In one example, the kiosk 100 can receive a image 105, like a photograph, from a user and generate an enlarged hard copy image 110 (also referred to as an output image) of the photograph in a selected size. For example, a small photograph can be scaled to a poster size and printed for the user while substantially retaining the characteristics of the original photograph. Thus, the kiosk 100 can provide an easy to use system that can generate one or more large format printed images on-demand within a relatively short processing timeframe. In one embodiment, the kiosk 100 includes computer processing logic that can be configured as a special purpose computer to perform desired functions and/or actions.

With further reference to FIG. 1, the kiosk 100 can include an image input device 115 configured to receive physical images (e.g., photographs, documents, and the like) that are desired to be reproduced by a user. The image input device 105 can also be configured to received image data in electronic form such as from a computer-readable medium. In one example the image input device 115 includes a scanner that can scan the physical image 105 and generate digital image data. An image processing logic 120 can be configured to process the digital image data to modify characteristics or properties of the image data. For example, the digital image data can be processed in accordance with one or more configurable settings or options that can be selected by the user, settings set as system defaults, and/or settings that are programmatically determined based on the quality of the inputted image 105, resolution, or other attributes that may help retain the resolution and other characteristics of the inputted image 105. One selectable option can include a desired size of the output image 110.

To generate the output image 110, an image forming system can be provided such as a large format print system 125 configured to print images on large format print media. The large format print system 125 can be operably connected internally or externally to the kiosk 100 or can be a stand-alone device. In one example, the large format print system 125 includes an inkjet printing mechanism capable of printing poster-size images on 24 inch by 36 inch sized print media. Other types of printing mechanisms can be used like those described below and of course, other sizes of output images can be created. In this manner, a user can generate enlarged sized duplicates of photographs or other images with the kiosk image processing system 100 that may be conveniently located in any public location.

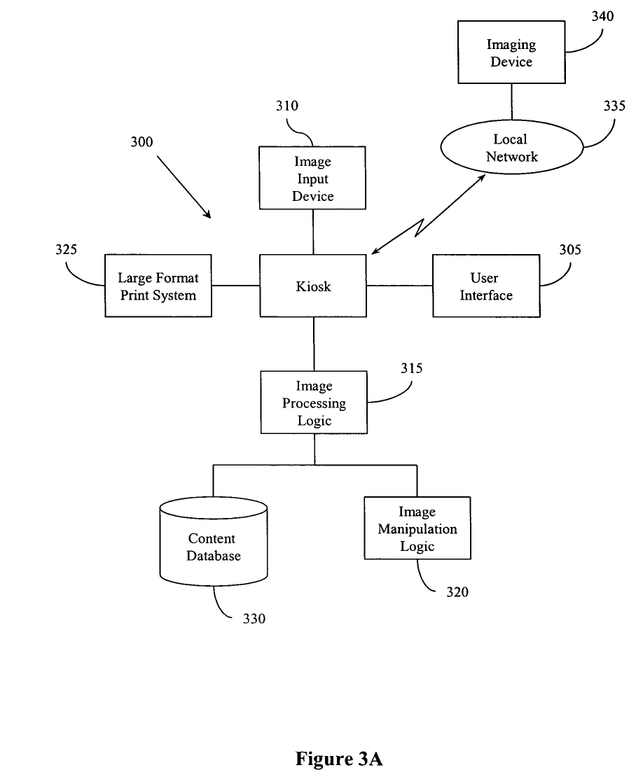

With reference to FIG. 2, an example methodology 200 is illustrated that can be associated with printing images on-demand with a kiosk imaging system. The example methodology 200 can initiate once a user activates the kiosk or otherwise initiates use of the kiosk. A physical image can first be inputted and received (Block 205) which is an image the user desires to have enlarged. Of course, it will be appreciated that the image can also be received in electronic form such as by receiving image data from a computer-readable medium. A digital image of the inputted image is generated (Block 210). Step 210 may not be required if the inputted image is inputted in electronic form. The digital image is then converted to a selected enlarged size (Block 215). Other types of image processing can also be performed on the digital image such as adding or combining the image with other image effects, adding text, modifying the properties of the image such as its lightness, darkness, contrast or other properties. It will be appreciated that many image processing options are available and that the described examples are not intended to be limiting.

Once the image data is processed and enlarged, the enlarged size of the digital image is printed on-demand (Block 220). In another example, the methodology can include prompting and receiving payment for the printing services as a condition for printing the image. The receipt of payment will be described in greater detail in other examples below.

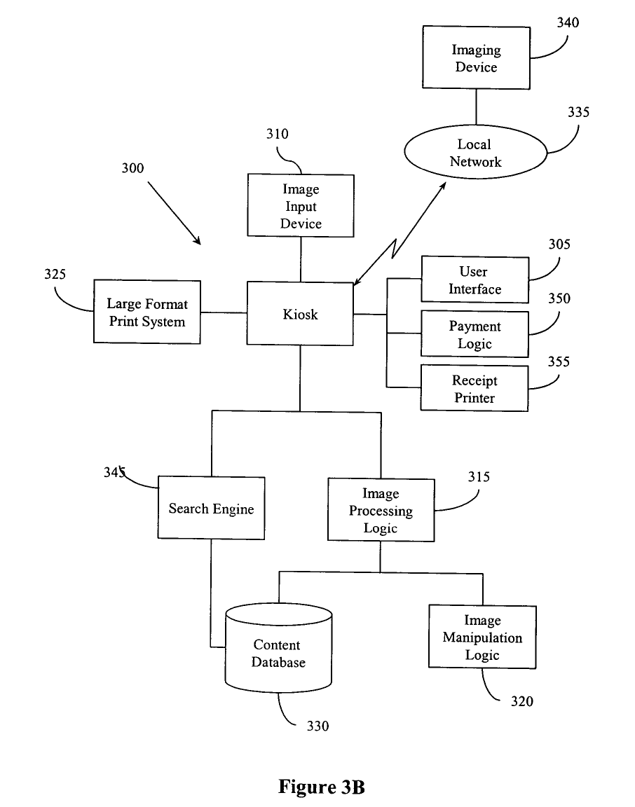

Illustrated in FIG. 3 is another example of a kiosk system 300 that is configured to generate on-demand large format images from a selected image. For example, the kiosk system 300 can generate a poster size image of a photograph within a short time period, e.g. a few minutes. The kiosk system 300 can be a processing device that includes components similar to a computer system. For example, it can include one or more processors, an operating system, memory, storage, network communications logic (Intranet/Intemet), a display, and other components as desired. The kiosk 300 can be configured to process user requests and to generate large format images on demand.

The kiosk system 300 can include a user interface 305 configured to communicate with a user to provide information to the user and receive information from the user. The user interface 305 may include a touch screen display and logic that communicates between the touch screen and the operating system of the kiosk 300. Of course, other types of input devices may be included such as a keyboard, mouse, or other input device. The user interface 305 can also include a display and logic configured to provide a preview image before actually printing a hardcopy enlarged image.

In order to generate a large format image, the user can input an original image, for example a photograph, into the kiosk 300 through an image input device 310. The image input device 310 may include a scanner that scans a physical photograph into electronic form. The image input device 310 can also include a device for reading and/or received data from a computer-readable medium such as a floppy disc drive, optical drive, memory card reader, digital camera, data communications logic, or other device that can process electronic data.

Image processing logic 315 is configured to process the inputted image to a final printing state which can then be printed on a large format medium. For example, image manipulation logic 320 can be configured to manipulate and change the characteristics of an image based on user-selected options. In that regard, the image processing logic 315 can include logic that communicates with the user interface 305 to direct the user through a variety of options using an easy-to-use tutorial style selection process with optional audio assistance. For example, through the user interface 305, the kiosk can present a variety of options that allows a user to change the characteristics of a selected image. For example, the user can be provided options to define a print area within the image (constrained or unconstrained), select a final size, crop the image, rotate, change the colors of the image, perform color correction, change brightness/contrast, add a border or other optical effects, add text to the image, or any desire image modification or enhancement desired.

Based on selected characteristics such as the original image's resolution and the final selected image size, the image processing logic 315 can be configured to calculate an optimal resolution based on the image size and can scale the image data appropriately. A print preview of the processed image data can be displayed to the user for approval. Once the image is approved by the user, the image data is sent to a large format print system 325 which is internal to the kiosk 300 and a large format print is generated onto a print media. In general, a large format print can be an image greater than 8″×10″, for example, 11″×17″, 12″×18″, 24″×36″, and other sizes.

With further reference to FIG. 3A, in another embodiment of the kiosk system 300, a content database 330 can be provided. The content database 330 can be a data store configured as a library containing image content, also referred to as image objects, that are available to users to print directly, combine with other image content, and/or include into a poster or other final printed image. For example, borders or clip art can be used to enhance a photograph or can be printed as a stand alone poster. Examples of content may include digital images of artwork, text, photographs, special effects, movie posters, borders, foreground/background overlay images or scenes, or any desired type of image or effect. The content may be obtained by generating each image and storing it within the kiosk 300 and/or by licensing and receiving the content from third parties. It will be appreciated that the content may be maintained in the kiosk in a variety of data stores and/or data structures including a database, linked lists, files, directories, objects or other desired way of organizing the content.

Once a user has either inputted an image into the kiosk to be produced in poster size and/or added content from the content database 330, the image is scaled to a desired size (e.g. 24″×36″) and the large format print system 325 reproduces the image on a printable medium. Examples of large format print system 325 configured to print large format image sizes can include an ink jet printer, an laser printer, a thermal printer. One example is an Epson 7600 model which is an ink jet printer. Of course, other types of ink-jet printers, laser-jet printers, or other types of large format print mechanisms may be used.

The large format print system 325 can include an image forming mechanism configured to generate an image onto print media. As described previously, the image forming mechanism may vary based on the type of imaging desired and may include a laser imaging mechanism, other toner-based imaging mechanisms, an ink jet mechanism, digital imaging mechanism, thermal printing mechanisms, or other imaging reproduction engine. One or more processors (not shown) may be included that is implemented with logic to control the operation of the large format print system 325. In one example, the processor includes logic that is capable of executing Java instructions. Other components of the large format print system 325 are not described herein but may include media handling and storage mechanisms, sensors, controllers, and other components involved in the imaging process.

In another embodiment, the kiosk 300 may include network logic (not shown) configured to communicate with a local network 335. With network communication, the kiosk 300 can transmit a final image through the local network 335 to an imaging device 340 for large format printing rather than performing the printing internally. This configuration may be used in a setting where users access the kiosk 300 but the imaging device 340 is controlled elsewhere. For example in a Kinko's establishment, the kiosk 300 may be accessible to customers but the imaging device 340 may be behind a counter operated by employees.

Illustrated in FIG. 3B is another example of the kiosk 300 that includes a search engine 345 and a payment logic 350. The search engine 345 can be configured to process search queries from a user trying to locate desired content from the content database 330. For example, the search engine 345 can provide an graphical interface that allows a user to input search criteria such as key words, categories, artist name, or other type of search criteria. The content database 330 can then be searched for content that matches or closely matches the search criteria. Results from the search can then be displayed to the user for selection. The search engine 345 can be embodied as software.

The payment logic 350 can be configured to request and process payments from a user for use of the kiosk system 300. In one example, the payment logic 350 can include a device for accepting cash payments and/or a device for accepting and processing credit/debit card payments. Based on the type of printing selected by a user, the cost associated the printing can be displayed and requested from the user. Upon receiving satisfactory payment, the payment logic 350 can transmit a signal that indicates such payment and that printing of the user request can proceed. The signal can also be sent to, for example, a receipt printer 355 that is caused to print a receipt and may include a bar code or other markings to associate the receipt to the current printing transaction.

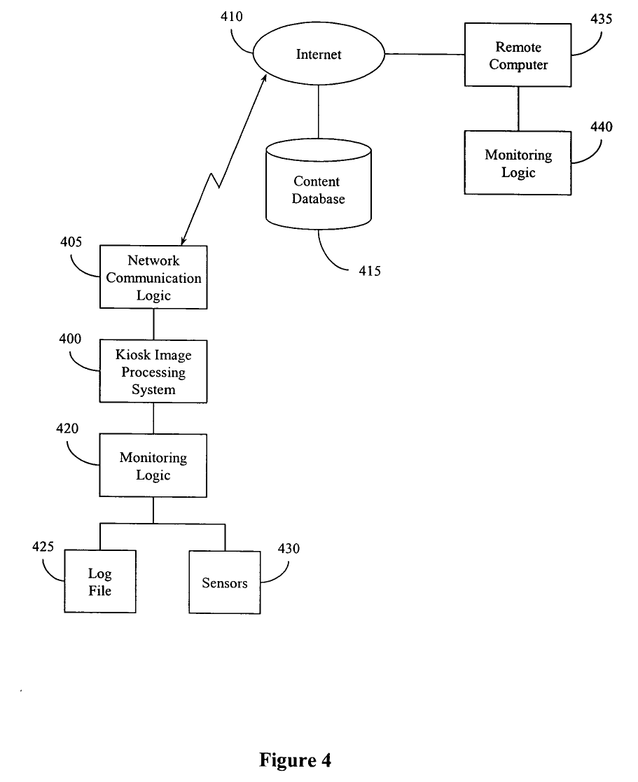

Illustrated in FIG. 4 is another embodiment of a kiosk image processing system 400 that includes network communication logic 405 that allows communication with the Internet 410 or other type of network. For example, a content database 405 may be maintained remotely and that can be accessed by a user through an Internet connection established by the network communication logic 405. The content database 415 can be similar to the database 330. Similar search capabilities may be included as in the embodiment where the content database is maintained within the kiosk 300. It will also be appreciated that a local area network may be used to maintain the content database 415 for use by the kiosk 400. With access to the content database 415, a user can search for desired content that can be combined with an image to produce a desired output image. With the content database 415 that is network accessible, the content database 415 can be a common centralized library of image content that is accessed by multiple kiosk systems positioned in multiple locations. One of ordinary skill in the art will further appreciate that a kiosk system may be configured to contain any combination of features from the other described kiosk examples.

With further reference to FIG. 4, one embodiment of a monitoring system is shown that is configured to monitor a variety of states and conditions within the kiosk 400. A monitoring logic 420 can be configured to track usage of the kiosk and store usage data and statistics within one or more log files 425. For example, the monitoring logic 420 may track how often the kiosk is used, how many users abort a print session before completion, a number of failed prints, statistics on which content was used and its frequency of use, which output poster sizes are used most often, and other usability statistics. By tracking which images from the content database 330/415 are used, the monitoring logic 420 can calculate any necessary licensing fees to be paid based on licensing agreements associated with the content.

The monitoring logic 420 may also be configured to monitor physical components and states within the kiosk 400. For example, one or more sensors 430 may be included within the kiosk 400 which communicate with the monitoring logic 420. The sensors 430 can also be configured to provide signals to the processor (not shown) of the kiosk 400. For example, sensors 430 may be included to monitor and provide signals relating to the paper level, the ink or toner level within the print system, wear levels of one or more components within the kiosk and/or the print system, and/or other components. The monitored and measured states within the kiosk 400 may then be accessed remotely through a Internet connection by a remote computer 435 operating a monitoring logic 440. In this manner, a system administrator or other person may access data from one or more kiosk systems 400 remotely by reading the monitored data recorded by each kiosk's monitoring logic 420. From the monitored data, decisions can be made as to when to replace paper, replace ink/toner, whether a kiosk needs repairs, and the like. The monitoring logic 440 may also be used to remotely push updates and/or upgrades of software on the kiosk system 400.

The monitoring logic 420 can also be configured to track usage of the one or more image objects in the content database 415 and provide usage data for maintaining the content database 415. The content database 415 can be maintained by, for example, removing unused or out-dated content, adding new content, modifying existing content, and so on. It will be appreciated that the monitoring logic 420 can also be included in the other kiosk configurations described herein, and which may include monitoring an internal content database such as the content database 330.

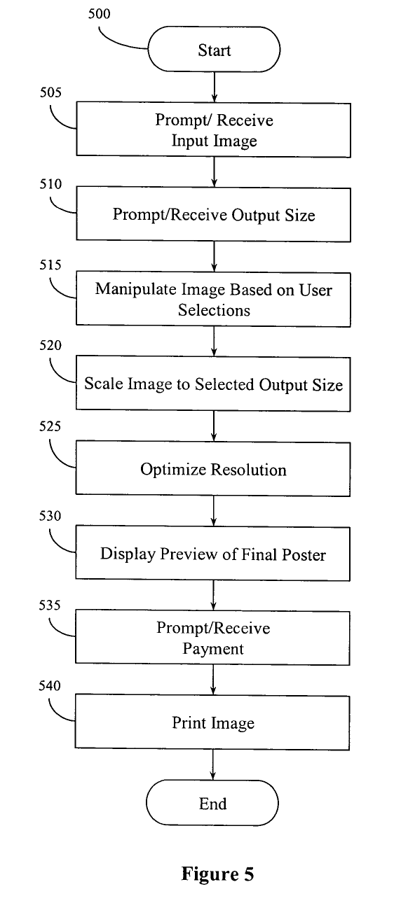

Illustrated in FIG. 5 is one embodiment of a methodology 500 associated with the operation of a kiosk to generate a large format print. The illustrated elements denote “processing blocks” and represent computer software and/or processor instructions or groups of instructions that cause a computer or processor to perform an action(s) and/or to make decisions. Alternatively, the processing blocks may represent functions and/or actions performed by functionally equivalent circuits such as a digital signal processor circuit, an application specific integrated circuit (ASIC), or other logic device. The diagram does not depict syntax of any particular programming language. Rather, the diagram illustrates functional information one skilled in the art could use to fabricate circuits, generate computer software and/or firmware, or use a combination of hardware and software to perform the illustrated processing. It will be appreciated that electronic and software applications may involve dynamic and flexible processes such that the illustrated blocks can be performed in other sequences different than the one shown and/or blocks may be combined or, separated into multiple components. They may also be implemented using various programming approaches such as machine language, procedural, object oriented and/or artificial intelligence techniques. The foregoing applies to all methodologies described herein.

With reference to FIG. 5, once a user initiates a printing process with a kiosk system, the system prompts the user for an input image to be used and receives the image (Block 505). Image data corresponding to the input image may be received by reading a physical image such as by scanning a photograph, reading a data file from a disk or other computer-readable medium, selecting an image from a content database, or by other means. The system can then prompt for and wait to receive a desired final output size (Block 510). If desired, the image data may be manipulated based on a variety of user selections (Block 515) so that a desired effect can be achieved. For example, image properties may be changed including lightness, darkness, contrast, defining an imaged region by cropping, adding a border or other image effects, zooming selected regions, overlaying other images, performing color correction or other image-altering algorithms. Based on a desired final size, the image data can be scaled to that size (Block 520). With this, an optimization algorithm may be performed to determine an optimal resolution of the image based on the output size selected (Block 525). If the original input image has a low resolution or quality that may be distorted once scaled to a larger size, the system may warn the user and allow the user to change the output size if desired.

At any time during the process, a user may request a preview of the final image and the system would display a preview of a final output image, for example, as a poster (Block 530). The process may also include payment options that prompt for and receive payment from the user based the printing options selected (Block 535). For example, the cost of printing an enlarged image can vary based on a number of prints requested, the size of the output image, the type of print medium selected, and the like. Payment can be received for example by a credit card reader, a cash receiving mechanism, or other payment receiving means. Once the payment is accepted, the output image is printed in the size selected (Block 540). It will be appreciated that the system can be configured to reproduce images of any size relative to the original input image and may even generate smaller, scaled-down images.

In general, the described kiosk image processing systems can be configured to provide a tutorial-like process that is easy to use and follow. For example, the tutorial-like process can be implemented through the user interface logic 305 and image processing logic 110/315. Any of the kiosks 100, 300, 400 can be configured to display a series of prompts on its display so that a user can easily select various options through touch-screen technology or other type of input formats. The image input device can allows a user/customer to easily select/input an original image including photographs, 35 mm slides, digital images from a digital camera, compact disc, DVD, negatives, or images from a content library. The image processing logic can then produce quality image reproductions of various sizes. Using an ink-jet print system, the system can produce posters including sizes of 24, 36 and 44 inches wide. Of course, other sizes may be obtained and other types of print systems can be used. The enlarged output images (e.g. posters) can be generated on-demand within a few minutes. However it will be appreciated that, as printing technology improves, the speed of the system can improve.

While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks.

While the illustrated flowcharts show various actions occurring in serial, it is to be appreciated that various actions could occur substantially in parallel. While each figure shows and describes a certain number of processes, it is to be appreciated that a greater and/or lesser number of processes could be employed and that lightweight processes, regular processes, threads, and other approaches could be employed.

In one example, methodologies described herein can be implemented as processor executable instructions and/or operations stored on a computer-readable medium. Thus, in one example, a computer-readable medium may store processor executable instructions operable to perform a method that includes some or all the processes of FIG. 2 and/or FIG. 5. While the above method is described being stored on a computer-readable medium, it is to be appreciated that other example methods described herein can also be stored on a computer-readable medium.

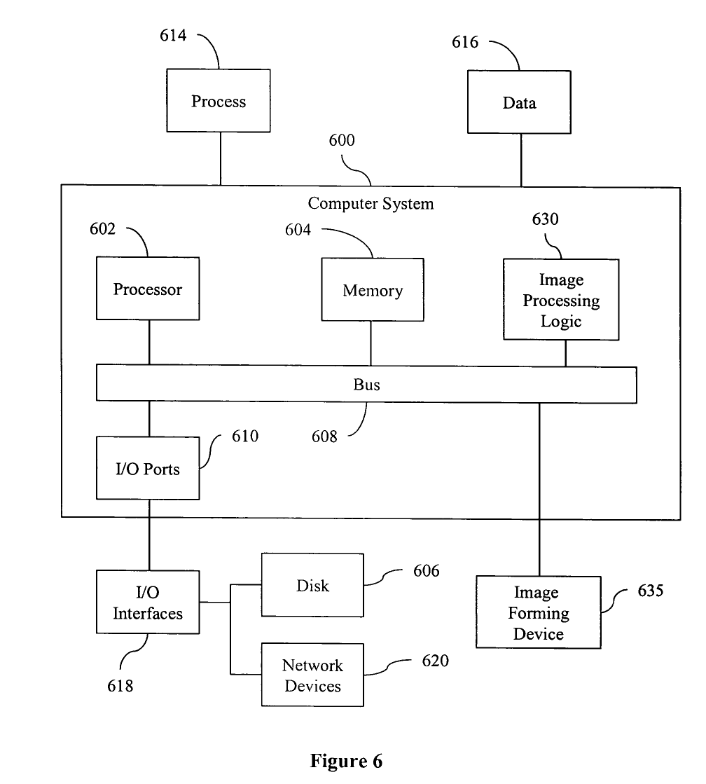

FIG. 6 illustrates an example of a computer system 600 that can be configured to act as a kiosk image processing system or that can be internal to a kiosk image processing system as described previously and act as a processing logic. The computer system 600 can include a processor 602, a memory 604, a disk 606, input/output ports 610, and a network interface 612 operably connected by a bus 608. The computer 600 may also include an image processing logic 630 similar to the example systems described herein. The image processing logic 630 may include, for example, a logic that performs the example executable methods described herein. It is to be appreciated that other computers may also be employed with the systems and methods described herein. An image forming device 635 can be operably connected to the computer system 600 where the image forming device 635 can be implemented as described previously relating to the large format print system, and may be permanently and/or removably attached to computer 600.

The processor 602 can be a variety of various processors including dual microprocessor and other multi-processor architectures. The memory 604 can include volatile memory and/or non-volatile memory. The non-volatile memory can include, but is not limited to, read only memory (ROM), programmable read only memory (PROM), electrically programmable read only memory (EPROM), electrically erasable programmable read only memory (EEPROM), and the like. Volatile memory can include, for example, random access memory (RAM), synchronous RAM (SRAM), dynamic RAM (DRAM), synchronous DRAM (SDRAM), double data rate SDRAM (DDR SDRAM), and direct RAM bus RAM (DRRAM). The disk 606 can include, but is not limited to, devices like a magnetic disk drive, a floppy disk drive, a tape drive, a Zip drive, a flash memory card, and/or a memory stick. Furthermore, the disk 606 can include optical drives like, a compact disc ROM (CD-ROM), a CD recordable drive (CD-R drive), a CD rewriteable drive (CD-RW drive) and/or a digital versatile ROM drive (DVD ROM). The memory 604 can store processes 614 and/or data 616, for example. The disk 606 and/or memory 604 can store an operating system that controls and allocates resources of the computer 600.

The bus 608 can be a single internal bus interconnect architecture and/or other bus architectures. The bus 608 can be of a variety of types including, but not limited to, a memory bus or memory controller, a peripheral bus or external bus, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 600 can be configured to interact with input/output devices 618 via input/output ports 610. Input/output devices 618 can include, but are not limited to, a keyboard, a microphone, a pointing and selection device, cameras, video cards, displays, and the like. The input/output ports 610 can include but are not limited to, serial ports, parallel ports, and USB ports.

The computer 600 can operate in a network environment and thus can be connected to network devices 620 by a network interface (NIC), not shown. Through the network devices 620, the computer 600 may interact with a network. Through the network, the computer 600 may be logically connected to remote computers. The networks with which the computer 600 may interact include, but are not limited to, a local area network (LAN), a wide area network (WAN), and other networks. The network interface can connect to LAN technologies including, but not limited to, fiber distributed data interface (FDDI), copper distributed data interface (CDDI), Ethernet/IEEE 802.3, token ring/IEEE 802.5, wireless/IEEE 802.11, Bluetooth, and the like. Similarly, the network interface can connect to WAN technologies including, but not limited to, point to point links, circuit switching networks like integrated services digital networks (ISDN), packet switching networks, and digital subscriber lines (DSL).

The image forming device 635 may also include an image forming mechanism configured to generate an enlarged output image onto print media from print-ready image data. The image forming mechanism may vary based on the type of the imaging forming device 635 and may include a laser imaging mechanism, other toner-based imaging mechanisms, an ink jet mechanism, digital imaging mechanism, thermal printing mechanism, or other imaging reproduction engine. A processor (not shown) may be included within the image forming device 635 that is implemented with logic to control the operation of the image forming device 635. In one example, the processor can include logic that is capable of executing Java instructions. Other components of the image forming device 635 are not described herein but may include media handling and storage mechanisms, sensors, controllers, and other components involved in the imaging process.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicants' general inventive concept. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the tern “includes” or “including” is employed in the detailed description or the claims, it is intended to be inclusive in a manner similar to the term “comprising” as that term is interpreted when employed as a transitional word in a claim. Furthermore, to the extent that the term “or” is employed in the claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. A kiosk image processing system, comprising:
an image input device configured to receive a physical image and cause a digital image to be generated from the physical image; and
image processing logic configured to process the digital image into a selected enlarged size; and
a large format print mechanism configured to print the digital image into a hardcopy image having the selected enlarged size.

2. The kiosk of claim 1 where the large format print mechanism is configured to print images greater than 8 inches by 11 inches.

3. The kiosk of claim 2 where the large format print mechanism includes an ink jet printer.

4. The kiosk of claim 1 where:
the image processing logic is configured to scale the digital image into a poster size; and
the large format print mechanism is configured to generate the hardcopy image in the poster size.

5. The kiosk of claim 1 where the image input device includes a scanner.

6. The kiosk of claim 1 further including a network logic configured to communicate to a network and where the image processing logic being configured to communicate the processed digital image to a remote imaging device for imaging.

7. The kiosk of claim 1 where the image processing logic further including an image manipulation logic configure to manipulate image characteristics of the digital image.

8. The kiosk of claim 1 further including an interface configured to communication information between a user and allow the user to select imaging properties to be applied to the digital image.

9. The kiosk of claim 1 where the large format print mechanism includes a laser printer.

10. The kiosk of claim 1 further including a content database means configured to store one or more content objects that can be selectively combined with the digital image to form the hardcopy image.

11. The kiosk of claim 10 further including a search engine configured to search the content database.

12. A method for a kiosk image processing system, comprising:
receiving an image;
generating a digital image of the image;
converting the digital image to a selected large format size; and
on-demand printing of a hardcopy image having the selected large format size.

13. The method of claim 12 where the converting includes scaling the digital image.

14. The method of claim 12 where the on-demand printing is performed by a large format printing mechanism.

15. The method of claim 12 where the receiving step includes scanning of a physical image.

16. The method of claim 12 where the receiving step includes reading data of the image from a computer-readable medium.

17. The method of claim 12 further including combining the digital image with one or more selected image objects accessible from a remote content database.

18. The method of claim 17 further including searching a content data base for the one or more selected image objects.

19. The method of claim 12 where the on-demand printing step is triggered by receiving payment from a user for the on-demand printing.

20. A kiosk image processing system comprising:
an image input device configured to receive an image;
a user interface configured to received selected options from a user;
an image processing logic configured to process the image based on the selected options and convert the image to a large format sized image;
a content database including one or more image objects that can be selectively combined with the large format sized image.
payment logic configured to receive an appropriate payment from the user; and
large format print mechanism configured to print the large format sized image on-demand if the appropriate payment has been received.

21. The kiosk image processing system of claim 20 where the large format print mechanism includes an image forming device means.

22. The kiosk image processing system of claim 20 where the large format print mechanism is configured to print images greater than 8 inches by 11 inches.

23. The kiosk image processing system of claim 20 where the large format print mechanism is configured to print images that are at least 11 inches by 17 inches.

24. The kiosk image processing system of claim 20 further including a monitoring logic configured to track usage of the kiosk image processing system and store usage data.

25. The kiosk image processing system of claim 24 where the usage data includes usage statistics.

26. The kiosk image processing system of claim 24 where the monitoring logic is configured to track usage of the one or more image objects in the content database and provide usage data for maintaining the content database.

27. The kiosk image processing system of claim 20 where the image processing logic further includes an image manipulation logic configured to manipulate and change image characteristics of the image based on the selected options.

28. The kiosk image processing system of claim 20 further including a search engine configured to search the content database.

29. The kiosk image processing system of claim 20 where the image processing logic includes means for processing the image.

30. The kiosk image processing system of claim 20 where the large format print mechanism includes on of: an ink jet printing mechanism and a toner based printing mechanism configured to print the large format sized image.

31. The kiosk image processing system of claim 20 where the content database is remotely maintained and accessible by network communication.
